(19) United States
(12) Patent Application Publication
(10) Pub. No.: US 2009/0007483 A1
(43) Pub. Date: Jan. 8, 2009

(54) Organofunctionally modified polysiloxanes and use thereof for defoaming liquid fuels with biofuel additions

(76) Inventors: Rene Hansel, Dorsten (DE); Andreas Vetter, Essen (DE); Sascha Herrwerth, Essen (DE); Andrea Lohse, Bottrop (DE); Joachim Venzmer, Essen (DE)

Correspondence Address: FROMMER LAWRENCE & HAUG, 745 FIFTH AVENUE- 10TH FL., NEW YORK, NY, 10151, US

(21) Appl. No.: 12/165,735

(22) Filed: Jul. 1, 2008

(30) Foreign Application Priority Data
Jul. 5, 2007 (DE) 10 2007 03 1287.5

(51) Int. Cl. C10L 1/28; C08G 77/14

(52) U.S. Cl. 44/320; 528/10

(57) ABSTRACT

The invention relates to organofunctionally modified polysiloxanes and to their use for defoaming liquid fuels, especially diesel fuels and diesel fuels to which biofuels have been added.

This application claims benefit under 35 U.S.C. 119 (a) of German patent application DE 10 2007 03 1287.5, filed on 5 Jul. 2007.

Any foregoing applications, including German patent application DE 10 2007 03 1287.5, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to organofunctionally modified polysiloxanes and to their use for defoaming liquid diesel fuels with biofuel additions.

The hydrocarbon mixtures used as diesel fuel, which may also include aromatics, gas oil, kerosene and biofuel additions, have the unpleasant property of evolving foam in conjunction with air when transferred into reservoir vessels such as storage tanks and fuel containers of motor vehicles. This leads to a delay in the transfer operation and to insufficient filling of the containers. It is therefore customary to add defoamers to the diesel fuel. These defoamers should be effective in a very low concentration and must not form any harmful residues in the course of combustion of the diesel fuel in the engine, or adversely affect the combustion of the fuel.

Polysiloxane-based defoamers are described in the patent literature.

The silicone polyether copolymers described there are effective because they are only very sparingly soluble in the diesel fuel and, owing to their surface-active properties, can accumulate and spread on the foam lamella. The destabilization of the foam lamella and hence the defoaming is a consequence from the spreading of the defoamer droplet. The induced flow of liquid in the foam lamella leads to the thinning and finally to the destruction of the foam lamella. The siloxane chain present in the silicone polyether copolymers provides the necessary low surface tension; the organic groups, added on as a side chain or end group on the siloxane, improve the compatibility in the diesel. The known copolymers, which are also referred to as polyether siloxanes or as organofunctionally modified polysiloxanes, and are described by the general formula

Me₃Si(OSiMe₂)ₓ(OSiMeR)_{y}OSiMe₃,

contain, as the R radical, a polyether which arises from addition of such monomers, such as propylene oxide, but more frequently ethylene oxide, onto starter alcohols such as allyl alcohol.

GB-B-2 173 510 (U.S. Pat. No. 4,690,688) relates to a process for defoaming diesel fuel or jet fuel, wherein an antifoam based on a silicone polyether copolymer whose polyether is described by the general formula Q(A)ₙOZ is added to the fuel. Q represents a difunctional group which is bonded to a silicon atom, A is an oxyalkylene group in which at least 80% are oxyethylene units, and Z is a hydrogen atom or another monofunctional group.

One disadvantage of this antifoam consists in the poor defoaming of wet diesel fuel. Wet diesel fuel is understood to mean a fuel which includes 250 ppm of water or more. This water is either water of condensation which gets into the fuel in the storage tanks, or it is introduced into the fuel during transport in oil tankers—as a result of the incomplete emptying of water in the tank.

DE-A-10 2004 018 926 describes the use of organically modified polysiloxanes as diesel defoamers, which are suitable especially for defoaming wet diesel fuel. The organically modified polysiloxanes used are polysiloxanes of the general formula

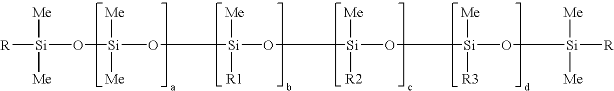

where
N is a+b+c+d+2=140 to 200, preferably 150 to 180,
a is 100 to 170, preferably 110 to 140,
b is 6 to 25, preferably 8 to 15,
c is 0.5 to 25, preferably 2 to 12,
d is 6 to 25, preferably 8 to 15,
   the R radicals are each independently methyl groups or R1, R2 or R3, with the proviso that at least 50% of the R radicals are not methyl groups, the R1 radicals are each independently identical or different hydrophobic polyether radicals of the general formula

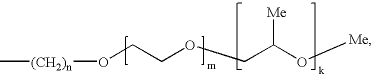

with the proviso that the molecular weight of the polyether is greater than 1000 g/mol and the proportion of propylene oxide is greater than 50%, where
n is 3 to 6,
m is 0 to 30,
k is 10 to 40,
the R2 radicals are each independently identical or different butylene oxide-containing polyether radicals of the general formula

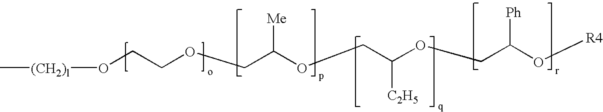

where
l is 3 to 6,
o is 0 to 30,
p is 0 to 25,
q is 1 to 30,
r is 0 to 30,
and R4 are each independently identical or different radicals from the group of methyl and hydrogen, the R³ radicals are each independently identical or different phenol derivatives of the general formula

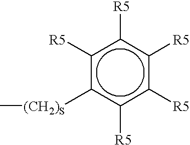

where R⁵ are each independently identical or different radicals from the group of alkyl, hydrogen, hydroxyl and alkoxy, with the proviso that at least one R⁵ radical is a hydroxyl group (a preferred phenol derivative is o-allylphenol).

DE-C-43 43 235 (U.S. Pat. No. 5,613,988) describes a process for defoaming diesel fuel, wherein organofunctionally modified polysiloxanes of the general formula

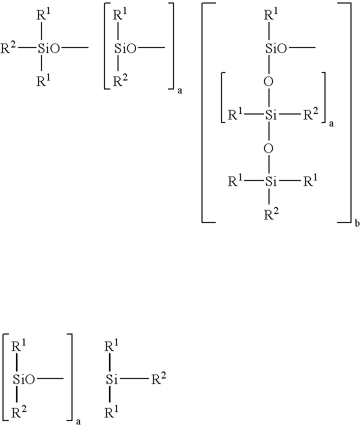

are used, where
the R¹ radicals are alkyl or aryl radicals,
the R² radicals are selected from more than one of the following compound classes: butene derivatives, alkanol derivatives, polyethers and alkyl radicals. These butylene derivatives and polyethers contain oxyalkylene units and oxypropylene units in a different composition.

U.S. Pat. No. 5,542,690 and U.S. Pat. No. 5,334,227 also describe the use of organopolysiloxanes for defoaming diesel fuel. In this case, the diesel defoamers used are polysiloxane terpolymers which have the structure MDₓD*_{y}D**₂M where M=O_{0.5}Si(CH₃)₃, D=OSi(CH₃)₂, D*=OSi(CH₃)R where R=a polyether, D**=OSi(CH₃)R′ where R′=phenol derivative, and x+y+z=35 to 350, x/(y+z)=3 to 6 and y/z=0.25 to approx. 9.0. The organopolysiloxanes described in U.S. Pat. No. 5,334,227 contain polyethers which consist of ethylene oxide units to an extent of more than 75% and do not have any butylene oxide units.

DE-C-195 16 360 describes a process for defoaming diesel fuel, wherein organofunctionally modified polysiloxanes of the general formula

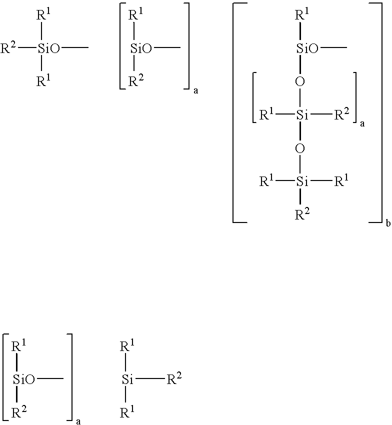

where a=1 to 400 and b=0 to 10 are used, where the R¹ radicals are alkyl or aryl radicals, the R² radicals are selected such that they are identical to the R¹ radical, but at least 10% is a phenol derivative and a further 10% is selected from more than one of the following compound classes: butylene derivatives, alkanol derivatives and alkyl radicals. Optionally, it is possible to use a polyether which has been formed from the monomers ethylene oxide and propylene oxide, and a starter alcohol.

EP-A-0 849 352 describes a process for defoaming diesel fuel, wherein silicone polyether copolymers which contain aromatic radicals and are of the general formula

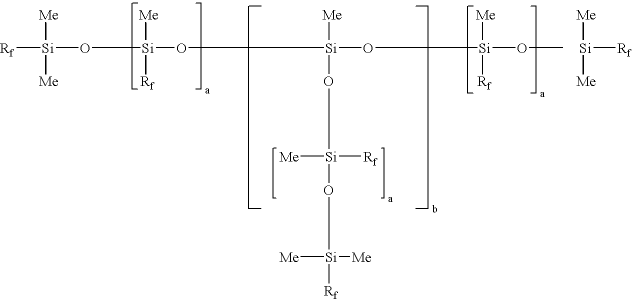

where b=0 to 8 and a 0 to 100 when b=6 to 8, a ═0 to 200 when b=3 to 6 and a ═0 to 300 when b=0 to 3 are used, where the R_{f} radicals are alkyl or aryl radicals, but at least 80% of the R_{f} radicals are methyl radicals. R_{f} is either R¹, where R¹ is an alkyl radical having 1 to 4 carbon atoms or an aryl radical, with the proviso that 80% of the R_{f} radicals are methyl radicals, or is R² or R³, with the proviso that at least one R_{f} radical is the R² radical, where R² is a polyether radical of the formula

—(Y)_{c}[O(C₂H_{4-d}R′_{d}O)ₘ(CₓH₂ₓO)ₚZ]_{w}

where Y is a (w+1)-valent hydrocarbon radical having 1 to 18 carbon atoms and Z=hydrogen or a monovalent organic radical, with the proviso that at least one R′ radical per copolymer molecule is an optionally substituted aromatic. c is 0 or 1, d is from 1 to 3, m is greater than or equal to 1, x is an integer from 2 to 4, p is greater than or equal to 1, w is from 1 to 4 and the sum of m+p is from 3 to 100.

R³ is an aromatic-free polyether radical of the formula

—(F)_{q}[O(CₓH₂ₓO)ᵣZ]_{g}

where g may be from 1 to 4, q is 0 or 1, x is from 2 to 4, r is greater than or equal to 3, F is a g-valent hydrocarbon radical which may also be branched and Z is as defined above.

More than 65% of the silicone polyether copolymers should contain an aromatic-containing polyether.

DE-A-197 26 653 describes the defoaming of diesel fuels with polysiloxanes of the general formula

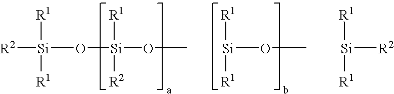

where
R¹ are alkyl radicals having 1 to 4 carbon atoms or aryl radicals, but at least 80% of the R¹ radicals are methyl radicals,
R² are the R^{2A}, R^{2B} and R^{2C} radicals, where the R^{2A} radicals are selected from the following radicals:
   (a) a phenyl derivative of the general formula

—R³—(C₆H_{4-z}R⁴_{z})—OR⁵
where
R³ is a divalent radical which is composed of one or more hydrocarbon radicals which have 1 to 18 carbon atoms and are optionally substituted,
R⁴ is a hydroxyl radical, an alkyl radical having 1 to 6 carbon atoms or an alkoxy radical having 1 to 6 carbon atoms, and
z is from 0 to 4,
R⁵ is a monovalent radical which is the same or different and consists of a hydrogen radical or alkyl radical having 1 to 6 carbon atoms,
(b) a polyether radical of the general formula

—(Y)[O(C₂H_{4-d}R⁶_{d}O)ₘ(CₓH₂ₓO)ₚZ]_{w}
with the proviso that
d is 1 to 3,
m is >1,
x is 2 to 4,
p is >1,
w is 1 to 4,
the sum of m+p=3 to 100,
R⁶ is a hydrogen radical, a monovalent hydrocarbon radical which has 1 to 18 carbon atoms and may also be aromatic and may optionally also be a substituted aromatic whose substituents are selected from the group of hydrogen radical, alkyl radical having 1 to 6 carbon atoms, alkoxy radical and hydroxyl radical, where the R⁶ radicals may be different, but at least one R⁶ radical per copolymer molecule is an optionally substituted aromatic,
Z is a hydrogen radical or a monovalent organic radical,
Y is a (w+1)-valent hydrocarbon radical which may also be branched,
the R^{2B} radicals are selected from the following radicals:
(c) an alkene derivative of the general formula

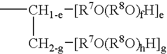

where
R⁷ is a radical of the formula —CR⁹H— where R⁹ is a hydrogen atom or monovalent organic radical,
R⁸ is a radical of the formula C₂H_{4-d}R¹⁰_{d}
   where
   R¹⁰ is a hydrogen atom or monovalent hydrocarbon radical which has 1 to 18 carbon atoms and may also be aromatic and optionally also be a substituted aromatic whose substituents are selected from the group of hydrogen radical, alkyl radical having 1 to 6 carbon atoms, alkoxy radical and hydroxyl radical, where the R¹⁰ radicals may be different,
e and g are each 0 or 1, where the sum of e+g is 1 or 2,
f and h are each 0 or an integer, where the sum of f+h is an average of 0 to 14,
(d) the —(CH₂—)ᵢOR¹¹ radical
   where
   R¹¹ is a hydrogen radical or a monovalent organic radical,
   i is 2 to 20,
(e) the —(CH₂—)ⱼCH₃ radical
   where
   j is 5 to 30,
(f) the R^{2C} radical, the radical —(CH₂—) k (OC₂H₄—)₁(OC₃H₃—)ₙOR¹²
   where
   R¹² is a hydrogen radical or a monovalent organic radical,
   k is 2 to 6,
   l is 1 to 50,
   n is 0 to 20,
      with the proviso that at least 10% of the R² radicals are the R^{2A} radical,
      where at least 10% of the R^{2A} radicals are the (a) radical and at least 10% are the (b) radical,
      the sum of a+b is 2 to 400 and the ratio of the numbers b/a is 0.2 to 20.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The defoamers are typically incorporated into the fuel in conjunction with additive packages. These additive packages are added to the crude diesel to improve its properties. Additive packages are understood to mean mixtures of different additives, for example agents for improving the combustion performance, agents for reducing soot formation, agents for reducing the formation of harmful exhaust gases, inhibitors for reducing corrosion in the engine and its parts, surfactant substances, lubricants and the like. Such additive packages are described, for example, in GB-A-2 248 068 and in the journal Mineralöltechnik 37(4), 20 ff. The additives of the additive package are dissolved in an organic solvent to give a stock concentrate which is added to the crude diesel fuel.

In recent times, biofuels are added to diesel fuels. According to DIN EN 590, diesel fuel may contain up to five percent FAME (fatty acid methyl esters). Since the start of 2004, the addition of biofuel (also known as biodiesel) is being practiced in Germany. According to an agreement with the automobile industry, only FAME comprising the starting material of rapeseed oil methyl ester (RME) is used—i.e. no other substances which are likewise legally permissible. A diesel fuel with, for example, an addition of 5% FAME is referred to as B 5 diesel.

The prior art does not include any information as to whether the defoamers described there are suitable for defoaming diesel fuels which comprise biofuel additions. Owing to the different dissolution capacity, it was additionally not expected that organofunctionally modified siloxanes according to the prior art might be suitable as defoamers for diesel fuels which comprise biofuel additions.

It was therefore an object of the present invention to provide defoamers which are suitable for defoaming diesel fuels which comprise biofuel additions.

It has been found that, surprisingly, defoamers which are based on organopolysiloxanes of the formula I or Ia as described below are particularly suitable for defoaming diesel fuels which comprise biofuel additions.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right and hereby disclose a disclaimer of any previously described product, method of making the product or process of using the product.

The present invention therefore provides organically modified polysiloxanes of the formula Ia as described below, and also fuel compositions which comprise organically modified polysiloxanes of the formula I as defoamers, as described below.

The use of the organically modified polysiloxanes of the formula I or Ia as defoamers also allows defoaming of diesel fuels which have biofuel additions. Such defoaming is possible only to a limited degree, if at all, with other organopolysiloxanes according to the prior art. Especially in the case of an increase in the biofuel content in the diesel fuel, the effectiveness of the conventional defoamers is reduced to an increasing degree, which is manifested, for example, in a higher initial foam height and a reduced defoamer action after storage.

The use of the inventive defoamers also has the advantage that, both in dry and in wet diesel fuel, excellent defoaming with long-term stability is achieved. Wet diesel fuel is understood to mean diesel fuel which contains about 250 ppm of water or more, especially 250 to 1000 ppm of water.

In particular, it is also possible through the use of organically modified polysiloxanes of the formula I or Ia to defoam diesel fuels with biofuel additions, to which larger amounts than the currently allowed 5% FAME have been added.

In addition, the organically modified polysiloxanes of the formula I or Ia have excellent compatibility with additive packages which typically comprise diesel fuels, especially those with biofuel additions.

The inventive organically modified polysiloxanes and fuel compositions which comprise organically modified polysiloxanes are described by way of example hereinafter, without any intention that the invention be restricted to these illustrative embodiments. When ranges, general formulae or compound classes are specified below, these shall encompass not only the corresponding ranges or groups of compounds which are mentioned explicitly but also all sub-ranges and sub-groups of compounds which can be obtained by excluding individual values (ranges) or compounds. When, in the context of the present description, documents are cited, their contents shall be included completely in the disclosure content of the present invention. When, in the context of the present invention, compounds, for example organically modified polysiloxanes, which can have different units more than once are described, the units may occur in these compounds in random distribution (random oligomer) or ordered (block oligomer). Numerical data for units in such compounds should be understood as the mean averaged over all corresponding compounds.

The organically modified polysiloxanes according to the invention are characterized in that they satisfy the general formula Ia

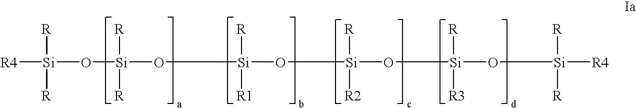

where
N is a+b+c+d+2=60.5 to 1000, preferably 120 to 250,
a is 50 to 960, preferably 80 to 200, more preferably 100 to 190,
b is 4 to 85, preferably 6 to 25, more preferably 10 to 20,
c is 0.5 to 85, preferably 0.5 to 10, more preferably 0.5 to 8,
d is 4 to 85, preferably 8 to 50, more preferably 10 to 20,
the R radicals are each independently identical or different, aliphatic or aromatic hydrocarbon radicals having 1 to 10 carbon atoms, preferably methyl groups,
the R1 radicals are each independently identical or different polyether radicals of the general formula IIa, with the proviso that either a random or a blockwise arrangement of the oxyalkylene units may be present

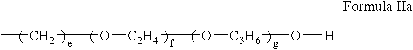

where
e is 3 to 11, preferably 3,
f is 0 to 60, preferably 1 to 20,
g is 0 to 60, preferably 10 to 30,
   preferably with the proviso that the molecular weight of the polyether is greater than 1000 g/mol, preferably greater than 1000 g/mol to 2000 g/mol, and the proportion of propylene oxide is greater than 50%, preferably greater than 65%,

the R2 radicals are each independently identical or different butylene oxide-containing polyether radicals of the general formula IIIa, with the proviso that either a random or a blockwise arrangement of the oxyalkylene units and, if present, styrene oxide units may be present

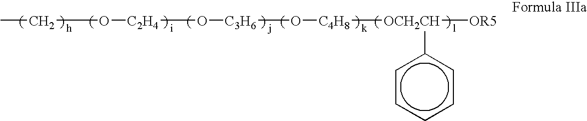

where
h is 3 to 11, preferably 3 to 6, preferentially 3,
i is 0 to 60, preferably 1 to 30,
j is 0 to 65, preferably 0 to 20,
k is 1 to 60, preferably 2 to 10,
l is 0 to 60, preferably 0 to 30, preferentially 0,
the R5 radicals are the same or different and are each independently methyl, acetyl or hydrogen radical, preferably hydrogen or methyl radical, more preferably hydrogen radical,
the R3 radicals are each independently identical or different phenol derivatives of the general formula IVa

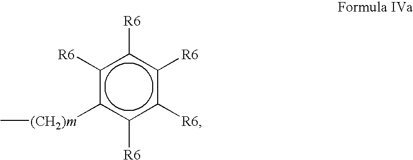

the R6 radicals are each independently identical or different radicals from the group of alkyl, hydrogen, hydroxyl or alkoxy, with the proviso that at least one
R6 radical is a hydroxyl group,
where the index m is an integer of 3 to 11, and
the R4 radicals are each independently identical or different R, R1, R2 or R3 radicals.

Particularly preferred compounds of the formula Ia are those in which N a+b+c+d+2=120 to 250, a=100 to 190, b=10 to 20, c=0.5 to 8, d=10 to 20, the R radicals are methyl groups, the R1 radicals are identical or different polyether radicals of the general formula IIa, where e=3, f=1 to 20, g=10 to 30, with the proviso that the molecular weight of the polyether radical is greater than 1000 g/mol, preferably greater than 1000 to 2000 g/mol, and the proportion of propylene oxide is greater than 65%, the R2 radicals are identical or different butylene oxide-containing polyether radicals of the general formula IIIa, where h=3, i=1 to 30, j=0 to 20, k=2 to 10, l=0 and the R5 radicals are hydrogen radicals. The inventive organically modified polysiloxanes of the formula Ia may be used especially as defoamers for fuel compositions which comprise diesel fuel or heating oil and preferably biofuel.

The inventive fuel compositions comprising diesel fuel or heating oil (i.e. fossil fuel components), biofuel and at least one defoamer are characterized in that the defoamers present are organically modified polysiloxanes of the general formula (I)

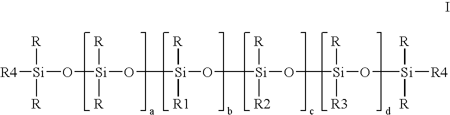

where
N is a+b+c+d+2=60.5 to 1000, preferably 120 to 250,
a is 50 to 960, preferably 80 to 200, more preferably 100 to 190,
b is 4 to 85, preferably 6 to 25, more preferably 10 to 20,
c is 0.5 to 85, preferably 0.5 to 10, more preferably 0.5 to 8,
d is 4 to 85, preferably 8 to 50, more preferably 10 to 20,
   the R radicals are each independently identical or different, aliphatic or aromatic hydrocarbon radicals having 1 to 10 carbon atoms, preferably methyl groups,
   the R1 radicals are each independently identical or different polyether radicals of the general formula II, with the proviso that either a random or a blockwise arrangement of the oxyalkylene units may be present

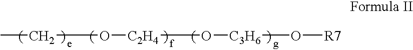

where
e is 3 to 11, preferably 3,
f is 0 to 60, preferably 1 to 20,
g is 0 to 60, preferably 10 to 30,
R7 is H, acetyl or methyl, preferably H,
preferably with the proviso that the molecular weight of the polyether is greater than 1000 g/mol, preferably 1000 to 2000 g/mol, and the content of propylene oxide is greater than 50%, preferably greater than 65%,

the R2 radicals are each independently identical or different butylene oxide-containing polyether radicals of the general formula III, with the proviso that either a random or a blockwise arrangement of the oxyalkylene units and, if present, styrene oxide units may be present

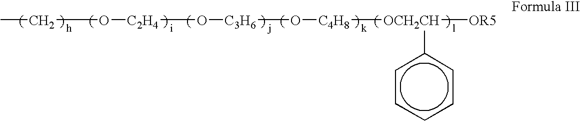

where
h is 3 to 11, preferably 3 to 6, preferentially 3,
i is 0 to 60, preferably 1 to 30,
j is 0 to 65, preferably 0 to 20,
k is 1 to 60, preferably 2 to 10,
l is 0 to 60, preferably 0 to 30, preferentially 0,
the R5 radicals are the same or different and are each independently methyl, acetyl or hydrogen radical, preferably hydrogen or methyl radical, more preferably hydrogen radical,

the R3 radicals are each independently identical or different phenol derivatives of the general formula IV

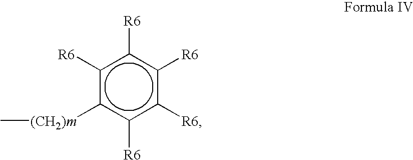

the R6 radicals are each independently identical or different radicals from the group of alkyl, hydrogen, hydroxyl or alkoxy, with the proviso that at least one
R6 radical is a hydroxyl group, where the index m is an integer of 3 to 11, and
the R4 radicals are each independently identical or different R, R1, R2 or R3 radicals.

The polyethers (formulae II or IIa and III or IIIa) can be obtained by adding monomers, for example ethylene oxide, propylene oxide, styrene oxide or butylene oxide, onto a starter alcohol, for example allyl alcohol. Such oxyalkyl chains may be arranged randomly or have a block structure. The preparation of such polyethers by alkaline catalysis, for example with potassium methoxide or sodium methoxide, can be taken from the prior art. The polyether radical R1 in formula II is preferably a hydroxy-functional polyether radical. The polyether radical R2 in the formula III or IIIa is a butylene oxide-containing polyether. Especially by virtue of the presence of a butylene oxide-containing polyether radical R2, particularly good defoamer properties are achieved in the case of use in fuel compositions which comprise diesel fuel or heating oil and a biofuel.

The R3 radicals are preferably a phenol radical or phenol derivative radical. Examples of corresponding phenol derivative radicals are eugenol radicals and allylphenol radicals, for example an o-allylphenol radical.

The organic radicals may be introduced into the molecule of the polysiloxane by addition of unsaturated derivatives (for example allyl or vinyl derivatives) onto SiH groups of the polysiloxane in the presence of a hydrosilylation catalyst, for example corresponding to the process of U.S. Pat. No. 5,334,227 or as described in “Silicones Chemistry and Technology” Vulkan Verlag Essen.

By virtue of the selection of the R1, R2 and R3 radicals and the ratio of these radicals relative to one another, it is possible to optimize the compatibility of the defoamer and thus to achieve an optimal defoaming action. More preferably, the inventive fuel composition comprises an organically modified polyorganosiloxane which is a relatively high molecular weight siloxane (where N>100, preferably >140) and in which the R1 radicals are identical or different polyethers having a molecular weight between 1000 and 2000 g/mol and a proportion of propylene oxide of greater than 65% by weight, and the R2 radicals are butylene oxide-containing polyethers.

Very particular preference is given to those fuel compositions which, as an organically modified polysiloxane of the formula I, comprise an inventive polysiloxane of the formula Ia.

The inventive diesel composition may either comprise no water (“dry diesel”) or else have a significant water content. Such a “wet diesel” may, for example, have a content of 250 ppm by mass of water and be obtained, for example, by addition of water to dry diesel.

The organically modified polysiloxanes of the formula I or Ia to be used in accordance with the invention can be added directly to the diesel fuel. However, it is preferred in practice to add the defoamer to the so-called additive package. The additive package comprises essentially a detergent, a demulsifier/dehazer and cetane number improver. In order to improve the compatibility of the organically modified polysiloxane to be used in accordance with the invention with the additive package, it may be advantageous to add the defoamer in a mixture of 2-ethylhexanol or glycols or aromatic-containing solvents.

According to the foaming behaviour of the diesel, the proportion of organically modified polysiloxane of the formula I or Ia in the fuel composition may vary. The content of organically modified polysiloxane of the formula I or Ia in the fuel composition is preferably 2 to 15 ppm by mass, more preferably 4 to 8 ppm by mass. The proportion of biofuel in the inventive biofuel composition may in principle be as desired. In the inventive fuel composition, the proportion of biofuel is preferably greater than or equal to 4% by weight, preferably greater than or equal to 5% by weight and more preferably greater than or equal to 10% by weight. One or more biofuels may be present in the inventive fuel composition. When a plurality of biofuels are present in the inventive fuel composition, the data given above for the proportion of biofuel relates to the sum of all biofuels.

The biofuel present may be the inventive composition, for example a biofuel based on FAME (fatty acid methyl esters), preferably based on rapeseed oil methyl ester.

The invention is further described by the following non-limiting examples which further illustrate the invention, and are not intended, nor should they be interpreted to, limit the scope of the invention.

### Preparation of the Defoamer E1:

A mixture of 22.3% by weight of α,ω-SiH-functional and pendant SiH-functional polydimethylsiloxane (where N=approx. 190 and 0.26% by weight of hydrogen) is initially charged with 16.7% by weight of aromatic-containing solvent (Solvesso 150). To this are added 43.0% by weight of an allyl alcohol-started copolymer consisting of 80% by weight of propylene oxide units and 20% by weight of ethylene oxide units and having a molar mass of 1400 g/mol (EO/PO polyether prepared according to the prior art by a KOH-catalysed reaction). In addition, 2.1% by weight of allylphenol and 15.9% by weight of an allyl alcohol-started copolymer consisting of 12 ethylene oxide units and 4 butylene oxide units (EO/BO polyether prepared according to the prior art by a KOH-catalysed reaction) are added. The mixture is heated to 90° C. with stirring. 5 ppm by mass of platinum are added in the form of a platinum catalyst. The monitoring of conversion by means of the SiH value (gas-volumetric determination) shows 99% SiH conversion after 5 h. The product is admixed with 5% propylene glycol.

### Preparation of the Defoamer E2:

A mixture of 19.9% by weight of SiH-functional polydimethylsiloxane (where N=approx. 190 and 0.26% by weight of hydrogen) is initially charged with 16.7% by weight of aromatic-containing solvent (Solvesso 150). To this are added 49.2% by weight of an allyl alcohol-started copolymer consisting of 65% by weight of propylene oxide units and 35% by weight of ethylene oxide units, and having a molar mass of 1600 g/mol (EO/PO polyether prepared according to the prior art by a KOH-catalysed reaction). In addition, 1.8% by weight of allylphenol and 12.4% by weight of an allyl alcohol-started copolymer consisting of 12 ethylene oxide and 4 butylene oxide units (EO/BO polyether prepared according to the prior art by a KOH-catalysed reaction) are added. The mixture is heated to 90° C. with stirring. 5 ppm of platinum are added in the form of a platinum catalyst. The monitoring of conversion by means of the SiH value (gas-volumetric determination) shows 99.5% SiH conversion after 5 h. The product is admixed with 5% propylene glycol.

### Defoaming Capacity:

To test the defoaming capacity of the inventive siloxanes, the defoamers are dissolved in an additive package according to the prior art. The additive package is used in the diesel at 320 ppm by mass as specified. The additive package comprises the defoamer in a concentration such that the defoamer is present in the diesel at 6 ppm by mass. The diesel used here contains less than 10 ppm by mass of sulphur.

As a comparison, the commercial defoamer TEGOPREN (TP) 5851 (silicone polyether copolymer from Goldschmidt GmbH) is tested.

The foam collapse of the diesel admixed with additive and defoamer is tested in a pressure apparatus (BNPé-Test: Determination of the foaming tendency of diesel fuels, NFM 07-075). This test is performed as follows: 100 ccm of diesel fuel are filled into a glass tube and subjected to a pressure of 0.4 bar. The glass tube is connected to a 250 ccm measuring cylinder via a solenoid valve at the bottom. The diesel is injected into the measuring cylinder via the valve. After the injection, the initial foam height and the time until the foam has decomposed are determined. The defoaming tests are each performed with dry and wet B 5 diesel and B 10 diesel.

Results of the defoaming tests:

### a) B 5 Diesel:

(Blank value is understood to mean B 5 diesel & additive package without defoamer.) B 5 diesel is understood to mean a mixture of 95% by weight of fossil diesel (sulphur content <10 ppm by mass) and 5% by weight of rapeseed oil methyl ester (biofuel addition).

| | Use | Foam | Foam | Foam | Foam de- |
|---|---|---|---|---|---|
| | con- | height | decomposition | height | composition |
| | centration | 0 day | time | 28 days | time |
| Defoamer | (ppm) | (ml) | (s) | (ml) | (s) |
| Blank | | 98 | 41 | 102 | 43 |
| value | | | | | |
| E 1 | 6 | 28 | 1 | 37 | 1 |
| E 2 | 6 | 31 | 1 | 38 | 1 |
| TP 5851 | 6 | 38 | 5 | 70 | 12 |

### Results in the Wet Diesel:

(250 ppm by mass of water were added to the B 5 diesel)

| | Use | Foam | Foam | Foam | Foam de- |
|---|---|---|---|---|---|
| | con- | height | decomposition | height | composition |
| | centration | 0 day | time | 28 days | time |
| Defoamer | (ppm) | (ml) | (s) | (ml) | (s) |
| Blank | | 107 | 42 | 101 | 44 |
| value | | | | | |
| E 1 | 6 | 31 | 1 | 35 | 1 |
| E 2 | 6 | 35 | 1 | 39 | 1 |
| TP 5851 | 6 | 55 | 8 | 78 | 14 |

### b) B 10 Diesel:

(Blank value is understood to mean B 10 diesel & additive package without defoamer.) B 10 diesel is 20 understood to mean fossil diesel (sulphur content <10 ppm by mass of sulphur), to which 10% rapeseed oil methyl ester (biofuel addition) has been added.

| | Use | Foam | Foam | Foam | Foam de- |
|---|---|---|---|---|---|
| | con- | height | decomposition | height | composition |
| | centration | 0 day | time | 28 days | time |
| Defoamer | (ppm) | (ml) | (s) | (ml) | (s) |
| Blank | | 105 | 40 | 100 | 45 |
| value | | | | | |
| E 1 | 6 | 32 | 1 | 39 | 1 |
| E 2 | 6 | 36 | 1 | 40 | 1 |
| TP 5851 | 6 | 48 | 8 | 78 | 16 |

### Results in the Wet Diesel:

(250 ppm by mass of water were added to the B 10 diesel)

| | Use | Foam | Foam | Foam | Foam de- |
|---|---|---|---|---|---|
| | con- | height | decomposition | height | composition |
| | centration | 0 day | time | 28 days | time |
| Defoamer | (ppm) | (ml) | (s) | (ml) | (s) |
| Blank | | 110 | 42 | 104 | 44 |
| value | | | | | |
| E 1 | 6 | 31 | 1 | 33 | 1 |
| E 2 | 6 | 30 | 1 | 35 | 1 |
| TP 5851 | 6 | 78 | 18 | 75 | 17 |

Having thus described in detail various embodiments of the present invention, it is to be understood that many apparent variations thereof are possible without departing from the spirit or scope of the present invention.

1. Organically modified polysiloxanes of the general formula Ia 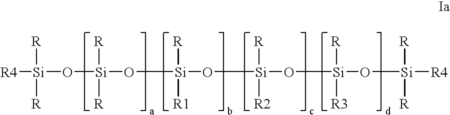
where
N is a+b+c+d+2=60.5 to 1000,
a is 50 to 960,
b is 4 to 85,
c is 0.5 to 85,
d is 4 to 85,
the R radicals are each independently identical or different, aliphatic or aromatic hydrocarbon radicals having 1 to 10 carbon atoms,
the R1 radicals are each independently identical or different polyether radicals of the general formula IIa, with the proviso that either a random or a blockwise arrangement of the oxyalkylene units may be present 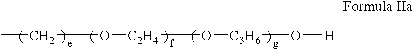
where
e is 3 to 11,
f is 0 to 60,
g is 0 to 60,
the R2 radicals are each independently identical or different butylene oxide-containing polyether radicals of the general formula IIIa, with the proviso that either a random or a blockwise arrangement of the oxyalkylene units and, if present, styrene oxide units may be present 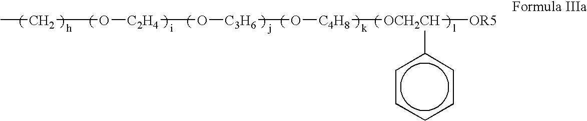
where
h is 3 to 11,
is 0 to 60,
j is 0 to 65,
k is 1 to 60,
1 is 0 to 60,
the R5 radicals are the same or different and are each independently methyl, acetyl or hydrogen radicals,
the R3 radicals are each independently identical or different phenol derivatives of the general formula IVa 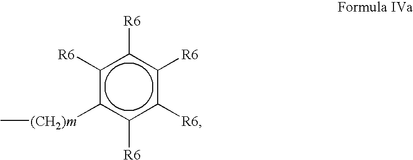
the R6 radicals are each independently identical or different radicals from the group of alkyl, hydrogen, hydroxyl or alkoxy, with the proviso that at least one R6 radical is a hydroxyl group, where the index m is an integer of 3 to 11, and
the R4 radicals are each independently identical or different R, R1, R2 or R3 radicals.

2. Organically modified polysiloxanes according to claim 1, characterized in that
N=a+b+c+d+2=120 to 250,
a=100 to 190,
b=10 to 20,
c=0.5 to 8,
d=10 to 20,
R=methyl group,
R1=each independently identical or different polyether radicals of the general formula IIa, with the proviso that e=3, f=1 to 20, g=10 to 30, the molecular weight of the polyether radical is greater than 1000 g/mol, and the proportion of propylene oxide is greater than 65% by weight, and
R2=each independently identical or different butylene oxide-containing polyether radicals of the general formula IIIa
where
h=3,
i=1 to 30,
j=0 to 20,
k=2 to 10,
l=0 and
R5=hydrogen radical.

3. Fuel composition comprising diesel fuel or heating oil, biofuel and at least one defoamer, characterized in that the defoamers present are organically modified polysiloxanes of the general formula (I) 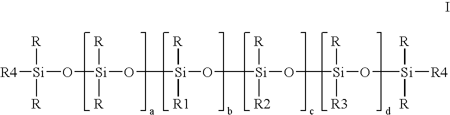
where
N is a+b+c+d+2=60.5 to 1000,
a is 50 to 960,
b is 4 to 85,
c is >0.5,
d is 4 to 85,
the R radicals are each independently identical or different, aliphatic or aromatic hydrocarbon radicals having 1 to 10 carbon atoms,
the R1 radicals are each independently identical or different polyether radicals of the general formula II, with the proviso that either a random or a blockwise arrangement of the oxyalkylene units may be present 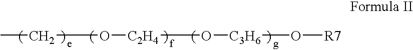
where
e is 3 to 11,
f is 0 to 60,
g is 0 to 60,
R7=H, acetyl or methyl,
the R2 radicals are each independently identical or different butylene oxide-containing polyether radicals of the general formula III, with the proviso that either a random or a blockwise arrangement of the oxyalkylene units and, if present, styrene oxide units may be present 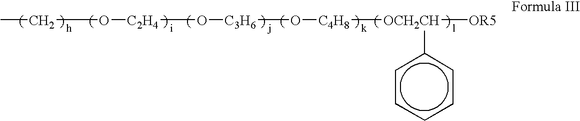
where
h is 3 to 11,
i is 0 to 60,
j is 0 to 65,
k is 1 to 60,
l is 0 to 60,
the R5 radicals are the same or different and are each independently methyl, acetyl or hydrogen
radicals,
the R3 radicals are each independently identical or different phenol derivatives of the general formula IV 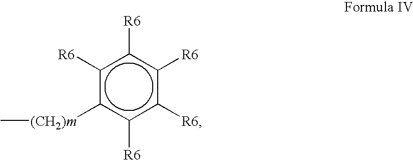
the R6 radicals are each independently identical or different radicals from the group of alkyl, hydrogen, hydroxyl or alkoxy, with the proviso that at least one R6 radical is a hydroxyl group, where the index m is an integer of 3 to 11,
and
the R4 radicals are each independently identical or different R, R1, R2 or R3 radicals.

4. Fuel composition according to claim 3, characterized in that the organically modified polysiloxane of the formula I is a polysiloxane according to claim 1 or 2.

5. Fuel composition according to claim 4, characterized in that the proportion of organically modified polysiloxane in the fuel composition is 2 to 15 ppm by mass.

6. Fuel composition according to claim 5, characterized in that the proportion of biofuel is greater than or equal to 4% by weight.

7. Fuel composition according to claim 6, characterized in that the biofuel present is a biofuel based on fatty acid methyl esters.
